(19) United States
(12) Patent Application Publication
(10) Pub. No.: US 2017/0372281 A1
(43) Pub. Date: Dec. 28, 2017

(54) SYSTEMS AND METHODS FOR RECOMMENDATIONS FOR PURCHASES BASED ON ACCUMULATION OF PURCHASES DIFFERENTIATING BETWEEN LOCAL AND TOURISTS TRANSACTIONS

(71) Applicant: VISA International Service Association, San Francisco, CA (US)

(72) Inventors: Ruben Salazar Genovez, Singapore (SG); Eden Smith, San Francisco, CA (US); James Cao, Foster City, CA (US); Kellen Mannion, San Francisco, CA (US); Qilu Xie, San Francisco, CA (US); John Stephen, Redwood City, CA (US)

(21) Appl. No.: 15/191,502

(22) Filed: Jun. 23, 2016

(51) Int. Cl. G06Q 20/10; G06F 17/30

(52) U.S. Cl. CPC G06Q 20/102; G06F 17/30241; G06F 17/30864

(57) ABSTRACT

Using payment processing data on which cards transact at a merchant, a payment transaction service provider may determine whether cards used at a given merchant are being used within the card's domicile or outside the domicile. When a card is used in domicile, that's a “local” user. This allows the payment transaction service provider to inform on whether a merchant is visited primarily by tourists or primarily by locals. The payment transaction service provider may also derive whether someone is a ‘tourist’ card based on any recent hotel, car rental, or flight purchases in the same location as their purchase at a merchant.

### FIELD OF INVENTION

This invention generally relates to a geocentric merchant information management system and method by a payment processing network and service provider.

### BACKGROUND

It is no secret that the world is getting smaller each day—thanks to the technological advancements. Anything from better and faster mode of transportation and new/faster transportation routes to mobile devices and ever expanding wireless telecommunication networks. At the same time, commercial activities are drawing people closer like never before. Payment mechanisms have been more diverse and collaborations of payment networks are increasing at an amazing speed. These innovations can make travelers feel like home at any places.

Frequent travels also generate more commercial activities. Despite the ever-growing international trade and commerce, many local gems—delicacies, arts and crafts, etc.—still have strong local attractions instead of an international attention. This is by no means a disadvantage—many travelers appreciate finding and knowing this kind of local “favorites” because these give the character to the places they visit. These experiences also give the travelers unique and special memories during their travels.

Under the current practice, the travelers, once arrived at the travel destination, would look up popular social network websites or travel books to look for those local favored locations to shop, dine, and/or stay. Some of these websites and travel books, unfortunately, have not been updated and therefore will likely disappoint the travelers with outdated information. Other websites may appear to have the information but the information was posted by other users who don't really have a reliable or trustworthy source to support that. It is also unlikely that the travelers would always rely on asking random strangers for recommendations.

Similarly, some establishments may post local-favorite information or claims on their websites. Unfortunately, existing search engines fail accurately identifying and locating the relevant information because a query such as “San Francisco local-favorite sea food restaurants” may yield a plethora of search results that do not help the travelers to choose the most plausible ones.

Therefore, a better and more efficient solution is desirable where the “local” designation of establishments may be more accurately provided to users—locals and travelers alike. In addition, information such as the designation information may be combined with offers and promotions to generate additional business.

### SUMMARY

Embodiments of the invention may provide intelligent and additional geocentric designations of one or more vendors/establishments in response to an aggregate payment transaction history and trends. In one embodiment, the one or more vendors or establishments may be designated in one or more geocentric groups, such as (a) local (i.e., local favorite), (b) tourists-national (i.e., favored by domestic tourists), (c) tourists-intl (i.e., favored by international tourists), (d) all-national (i.e., favored by locals and domestic travelers), or (e) all (i.e., favored by all, whether it is a domestic or international travelers, or locals).

According to another embodiment, a payment processing network and a payment processing service provider may add the geocentric designator to the existing data protocol used in the payment processing network. For example, the geocentric designator may be represented by an extra bit or extra bits of information in the transmission of data packets in the payment processing network. In another embodiment, the payment processing service provider may create a dynamic merchant identification (ID) information that reflects the geocentric designation information. In this example, the dynamic nature of the merchant ID may take into consideration that vendors may change the geocentric designator as a result of changes of ownership, changes of local economy, change of location, change size of the establishments, etc.

### BRIEF DESCRIPTION OF THE DRAWINGS

The invention may be better understood by references to the detailed description when considered in connection with the accompanying drawings. The components in the figures may not necessarily be to scale, emphasis instead being placed upon illustrating the principles of the invention. In the figures, like reference numerals designate corresponding parts throughout the different views.

FIG. 1 illustrates an overview of a system of recommendations for purchases based on accumulation of purchases differentiating between local and tourists transactions according to one embodiment of the invention;

FIG. 2 illustrates a table diagram of a plurality of transactions for a payment processing provider according to one embodiment of the invention;

FIG. 3 illustrates a table diagram of a plurality of transactions for a payment processing provider where a plurality of geocentric groups is designated according to one embodiment of the invention;

FIG. 4 illustrates a diagram of exemplary data structure of a data packet with a geocentric designator according to one embodiment of the invention;

FIG. 5 illustrates a flow diagram of a method of recommendations for purchases based on accumulation of purchases differentiating between local and tourists transactions according to one embodiment of the invention;

FIG. 6 is an illustration of a portable computing device suitable for aspects of the invention; and

FIG. 7 is an illustration of a server computing device suitable for aspects of the invention.

Persons of ordinary skill in the art may appreciate that elements in the figures are illustrated for simplicity and clarity so not all connections and options have been shown to avoid obscuring the inventive aspects. For example, common but well-understood elements that are useful or necessary in a commercially feasible embodiment may often not be depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein may be defined with respect to their corresponding respective areas of inquiry and study except where specific meanings have otherwise been set forth herein.

### DETAILED DESCRIPTION

The present invention may now be described more fully with reference to the accompanying drawings, which form a part hereof, and which show, by way of illustration, specific exemplary embodiments by which the invention may be practiced. These illustrations and exemplary embodiments may be presented with the understanding that the present disclosure is an exemplification of the principles of one or more inventions and may not be intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

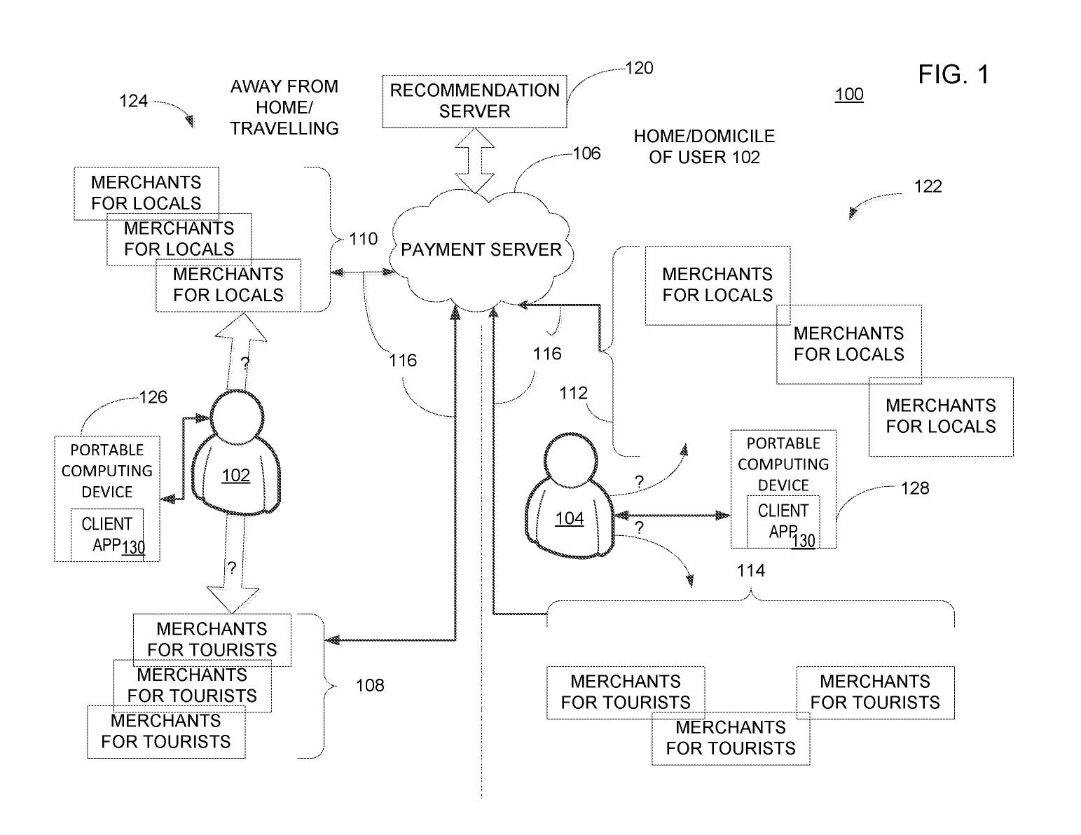

Referring now to FIG. 1, a diagram illustrates a system 100 of an intelligent recommendations for purchases based on accumulation of purchases differentiating between local and tourists transactions according to one embodiment of the invention. In one embodiment, the system 100 may include one or more payment processing servers 106 for processing payment transactions. For example, a payment processing service provider may configure the system 100 to include the one or more payment processing servers 106 at different physical locations to convenient process payments. In one embodiment, the system 100 further includes one or more payment processing networks 116 implemented throughout the system 100. For example, the one or more payment processing networks 116 may include proprietary network schemas and protocols that are highly encrypted or structured to ensure security and privacy of the data packets transmitted thereon. In another embodiment, the one or more payment processing networks 116 may interface, according to the protocol, unsecured networks, such as the Internet, for limited purposes. For example, the one or more payment processing networks 116 may include a portal hosted on the Internet for login, etc. However, once the proper credentials are verified, a user may then be on the secured payment processing networks 116.

In another embodiment, the one or more payment processing servers 106 may be connected to or coupled to a recommendation server 120 and/or a data storage unit (not shown). For example, the recommendation server 120 includes computer executable instructions to process data from the one or more payment processing servers 106 to further process and analyze transactions handled by the payment processing servers 106. In a further embodiment, the one or more payment processing servers 106 include processors or microprocessors configured to execute computer executable instructions. For example, the one or more payment processing servers 106 in a distributed manner may configure their processors to execute computer executable instructions organized in modules. In one embodiment, the one or more payment processing servers 106 may include an analysis module and an accumulation module for specific processing needs. In another embodiment, the different modules handled by the one or more payment processing servers 106 may be in the form of a dedicated hardware piece (e.g., specifically manufactured processor chips) or in the form of software program products.

Similarly, the recommendation server 120 may include modules as well, such as a query module, an output module, etc.

The system 100, with the organization of the one or more payment processing servers 106, the recommendation server 120, and the one or more payment processing networks 116, may handle tens of thousands of payment transactions around the world each second. For example, using FIG. 1 as an illustration, the one or more payment processing networks 116 may handle transactions from a set of merchants 112 and 114, for a user 102 whose home/domicile 122 may be in one locale and the home/domicile 122. Similarly, when the user 102 is away from home or travelling at a location 124, and there are merchants or vendors 110 and 108. All of which may submit payment processing requests, through the payment processing networks 116, to the one or more payment processing servers 106.

One aspect of the invention may attempt to solve is to accurately and promptly making geocentric information about a vendor to the user 102 or a traveler 104. For example, when the user 102 is away from home, it would be helpful for the user 102 and the traveler 104 to receive object data sources when they travel.

Conventional and routine approach in the prior technology or habits was for the user 102 and the traveler 104 to look up, either prior to the trip or upon arrival at the destination, “local” favorite from different information sources, such as social networking sites and search engines. The user 102 and the traveler 104 may also seek recommendations from hospitality concierge services, if available. However, sometimes the recommended vendors may be biased because the hospitality concierge may have separate arrangements with the vendors. In other words, there are no other independent and reliable source of information for the user 102 and the traveler 104 for them to further evaluate the recommendations.

Embodiments of the invention may build on payment transaction raw data and may perform further analysis thereto before designating or assigning geocentric information to enrich the payment processing data. Aspects of the invention may enhance the usability of the payment transaction raw data using objective information, and through accumulation and anonymization of data, privacy concerns of the information is minimized.

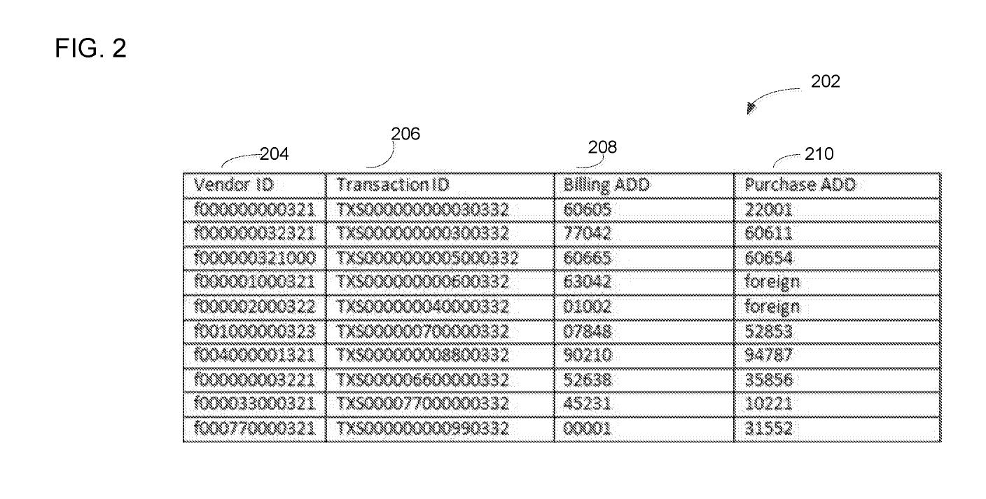

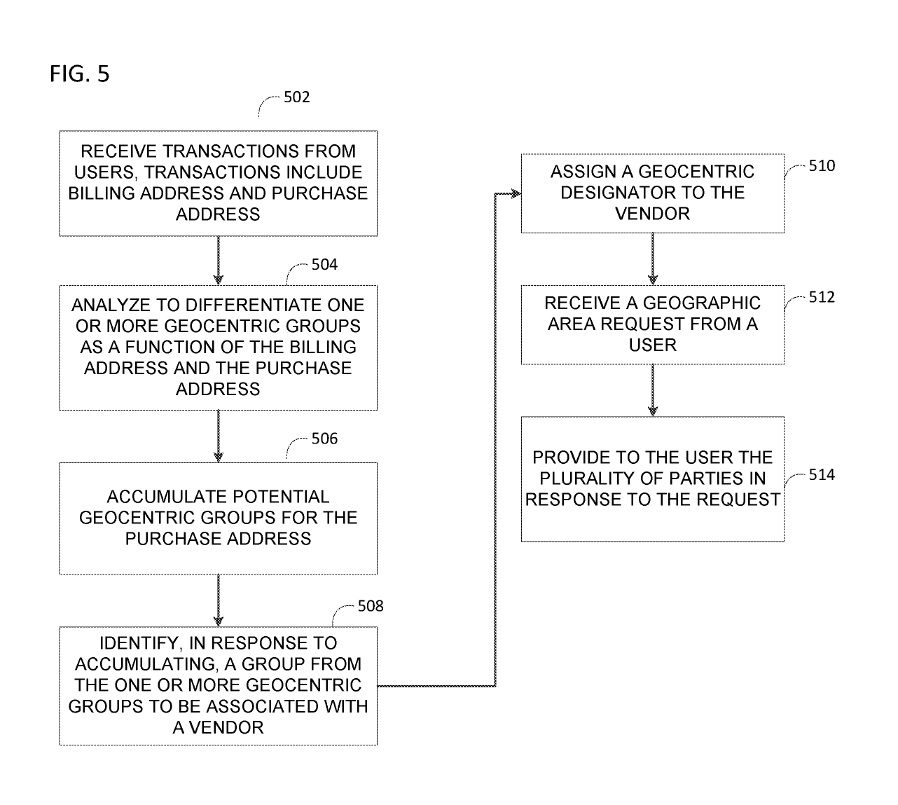

To further illustrate aspects of the invention, FIGS. 2-5 are discussed interchangeably in the following paragraphs. Referring first to FIG. 5, a flow diagram illustrates a method of recommendations for purchases based on accumulation of purchases differentiating between local and tourists transactions according to one embodiment of the invention. At 502, transactions may be received from a plurality of users, such as user 102 and traveler 104. For example, a plurality of users may make purchases each day at different locations. The payment processing servers 106 may receive the transactions transmitted through the payment processing networks 116 according to the specific protocols. In one embodiment, FIG. 2 illustrates a diagram 202 showing a snapshot of a simplified depiction of transactions arriving at the payment processing servers 106 according to one embodiment of the invention. For example, the diagram 202 may typically show a column 204 listing an identification (ID) for the vendor, a column 206 listing the ID for the transaction, a column 208 listing the billing address of a payment device, and a column listing the purchase address of the vendor. For the sake of illustration and not as a limitation, the column 208 and column 210 use the first five digits of the zip codes. If a zip code is not available, a text notation or other kinds of notation, such as “foreign” may be noted. It is to be understood that the diagram 202 may expand in size, e.g., having additional rows, as transactions are received. It is also understood that additional columns may be added to further include additional information in the payment transaction raw data.

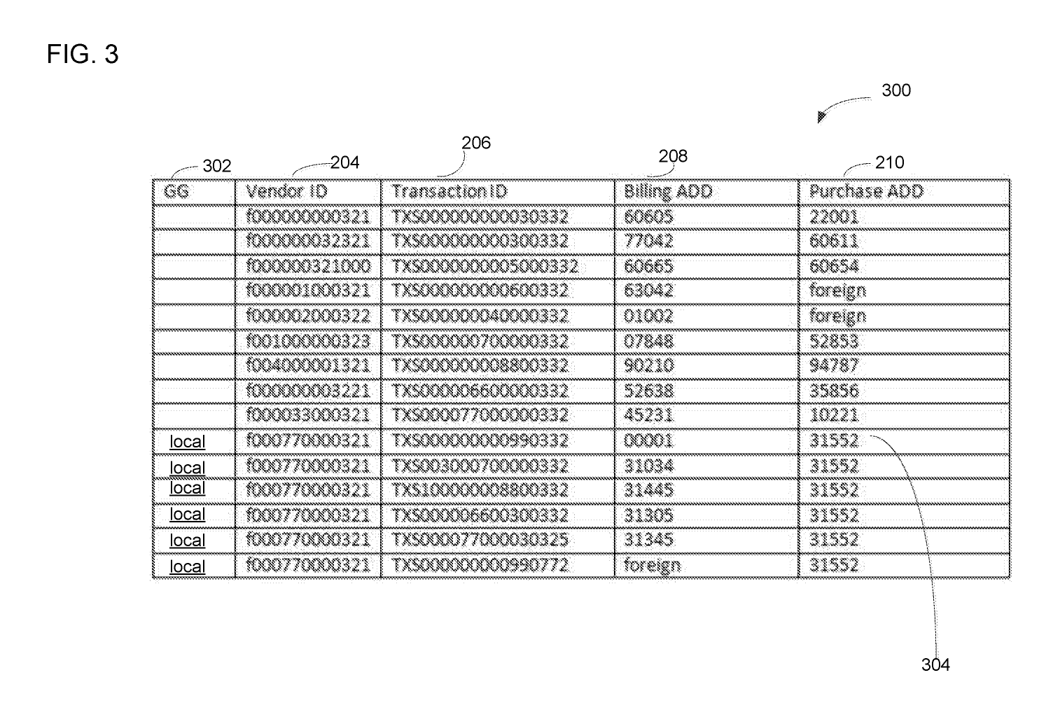

In contrast to FIG. 2, FIG. 3 illustrates an enhanced diagram 300 showing a new column 302 with the added geocentric group information, or abbreviated as “GG” in the column header. This new bit or piece of information is further described below.

Referring to FIG. 5 again, at 504, the payment processing servers 106 may analyze the plurality of transactions to differentiate them as a function of the billing address (e.g., first address) and the purchase address (e.g., second address) of the vendors. For example, using one of the vendor as an example in FIG. 3, based on the analysis, the payment processing servers 106 may have identified vendor ID “f000770000321” 304 as a differentiating vendor among those analyzed. A part of the vendor ID, “f” may be used to designate a food service or food provider. In differentiating the vendor 304, the payment processing servers 106 may have collected a number of other transactions in an analysis batch. In one embodiment, the analysis batch may be triggered by an administrator or a user based on queries. In another embodiment, the analysis batch may be triggered by automated processes according to a scheduled event by the payment processing servers 106. For example, the payment processing servers 106 may use the analysis module to conduct the analysis batch based on heuristics, i.e., transaction volume patterns, etc. Other triggering events for the analysis to take place may be configured without departing from the spirit and scope of the present invention.

As part of the analysis, the analysis module may compare and may review the correlations between the billing address information of the user (e.g., user 102 or traveler 104) and the purchase address information of the vendor. At 506, the payment processing servers 106 may use the accumulation module to accumulate potential geocentric groups for each purchase address. At 508, for each of the vendors, the payment processing servers 106 may identify, in response to accumulating, a group from the one or more geocentric groups to be associated with a party that satisfies a threshold geocentric value. For example, referring to FIG. 3 again, using the vendor 304 as an example, the diagram 300 shows that there are 6 transactions in a given time frame. These six transactions, after accumulating, show that four of them are made from billing addresses that are within a 10 mile radius of the purchase address of the vendor 304. The other two transactions have 00001 and a foreign notation for the billing addresses. Before designating the vendor 304 as a “local” vendor, the payment processing servers 106 may evaluate the accumulate data based on a threshold geocentric value. In this simplified example, the payment processing servers 106 has determined that the majority of the transactions (4 out of 6) are within a 10-mile radius. Hence, this meets the threshold geocentric value of, for example, 51% for this particular vendor to be identified as a “local.” In one embodiment, the threshold geocentric value may be based on the number of transactions in a given time, population of the purchase address in question, relative area size of the purchase address, etc. In other words, the payment processing servers 106 may determine the threshold geocentric value before identifying the group. The payment processing servers 106 may have a predetermined set of threshold geocentric values to use to determine how to narrow the scope of evaluation. In another embodiment, the user 102 may have an opportunity to set the threshold geocentric value.

In one embodiment, the payment processing servers 106, through modules described above or other modules, may execute computer executable instructions to define, assign or designate the status of the geocentric information of a vendor. For example, the following pseudo-codes or logics may be executed by the payment processing servers 106 to implement aspects of the invention:

DEFINE var vendT; /* define Tourist Merchant designation */
DEFINE var crossTrans; /* define cross border transactions */
DEFINE var localTrans; /* define local transactions */
DEFINE var monthTime; /* set time duration */
DEFINE var thresholdTrans; /* define threshold variable */
DEFINE var currentTime; /* set current time */
{ FOR monthTime = 30;

IF crossTrans > localTrans and
IF (crossTrans−localTrans)/localTrans > thresholdTrans
vendT = 1;

}

In such an example, it is to be understood that transactions data of a given vendor may come from transacting bank(s). The transacting bank(s) may, depending on the types of transactions (e.g., online or swiped), further throttle the transaction data to the payment processing servers 106. It is also assumed that there may be delays between the time the transaction that took place and the time the data is received at the payment processing servers 106. As such, in another embodiment, the payment processing servers 106 may update the data in the data storage unit on a periodic basis to account for transactions that belong to the previous time frame.

Furthermore, it is to be understood that, while the data storage unit may be used to store transaction data transmitted from the transaction bank(s), in some embodiments, the payment processing servers 106 may be able to evaluate the geocentric information or assign the geocentric designator in real time or substantially real time. For example, for big international events such as the Olympics, World Cup, Super Bowl, NCAA March Madness, etc., where transaction data are coming at an increased rate, the payment processing servers 106 may appropriately adjust the monthTime above to adjust for these changes and still provide appropriate geocentric designators.

Moreover, the threshold geocentric value may be adjusted based on a number of factors. For example, the threshold geocentric value may be adjusted depending on the population, the population change, government ordinances, state or federal laws, local taxes, existence of natural disasters, existence of catastrophic incidents, currency policy changes, etc., as these external factors may affect the composition of the economy surrounding the area where the vendor operates.

At 510, the payment processing servers 106, through a designator module, may designate a geocentric designator for the vendor 304. In this example, the payment processing servers 106 designate the vendor 304 as a “local” based on the 4 transactions from billing address associated with the transactions within a certain time period and within a certain geographical area. In another embodiment, the payment processing servers 106 may assign other designations as a function of the threshold geocentric value, the billing address, and the purchase address.

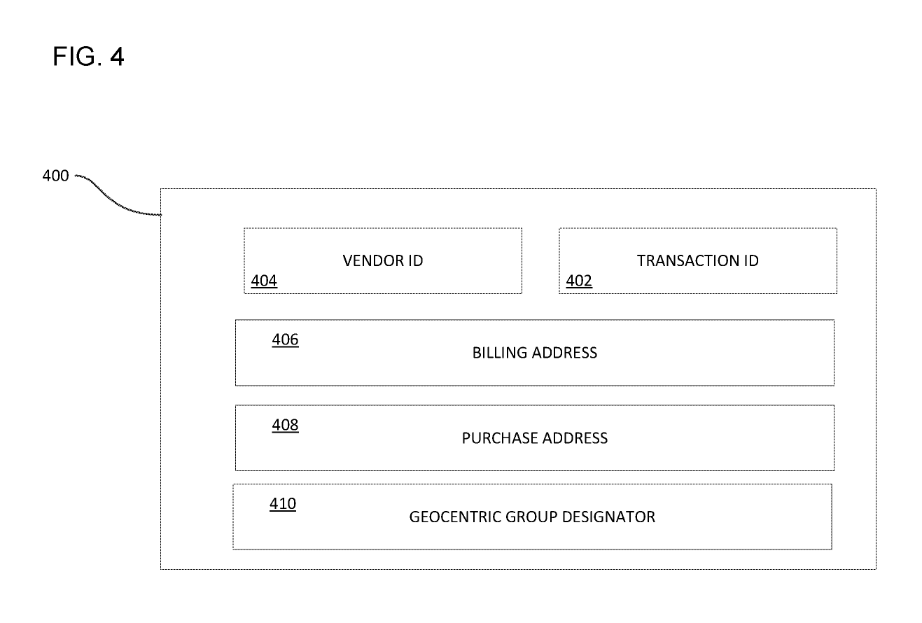

Referring now to FIG. 4, a diagram 400 illustrates an exemplary data structure of a data packet with a geocentric designator according to one embodiment of the invention. In one embodiment, a geocentric group designator data field 410 may be added or supplemented to the existing data packet protocols processed by the payment processing networks 116 and the payment processing servers 106. In one embodiment, the data structure 400 may include a transaction ID data field 402, a vendor ID data field 404, a billing address data field 406, and a purchase address data field 408. In one embodiment, the geocentric group designator data field 410 may include information or representation of one of the following groups: (a) local (i.e., local favorite), (b) tourists-national (i.e., favored by domestic tourists), (c) tourists-intl (i.e., favored by international tourists), (d) all-national (i.e., favored by locals and domestic travelers), or (e) all (i.e., favored by all, whether it is a domestic or international travelers, or locals) designation for vendors. It is to be understood that other designations may be developed that may be uniquely describe the vendor in a geocentric fashion.

In another example, the designator field 410 may be represented by 3-bit information, e.g., 000, 001, 010, 011, 100, 101, 110, and 111, each may represent one of the groups above. Other representation may be generated without the departing from the scope and spirit of the invention.

In a further embodiment, instead of treating the designator field 410 as a separate field, the designator field 410 may be dynamically incorporated into the vendor ID field 404 or other data fields. For example, suppose the vendor ID field 404 may be represented by a data field size of 64-bit or 128-bit. Using some of the “open” or “unused” bits, the vendor ID field 404 may dynamically incorporate the designator field 410 or the designator information such that the payment processing servers 106 may include more information in the payment transaction raw data without changing the existing protocol. This may enable the payment processing servers 106 to more efficiently process and update the payment transaction data. This embodiment may be especially useful because vendors may change they operations due to owner/management, location, size of the establishment, etc. Dynamically changing the vendor ID may be able to reflect these changes independently or through the geocentric group or designator.

Referring to FIG. 5 again, at 512, the recommendation server 120 may receive a geographic area request from a user, such as the user 102 and traveler 104. The request input may include a destination area code, which would be used to compare with the “purchase address” of the vendors. In another example, the request input may include one or more the geocentric group designations described above. The user may select more than one groups as part of the search criteria. At 514, the query module or an output module may provide to the user a result based on the geocentric designator of the plurality of parties.

In another embodiment, the result from the query module may also include offers provided by the different vendors shown in the result, depending on the geocentric groups. For example, suppose there is a local festival event at the locale of the vendor 304 and near the vendor 304. The vendor 304 may indicate to the payment processing servers 106 that it is willing to offer a 10% discount for any non-local residents to enjoy the festivities with the locals. Knowing that the payment processing servers 106 include the geocentric designators for vendors, the vendor 304 would appreciate that its offer would attract the right crowd because (1) the vendor 304 has been frequented by locals and (2) travelers would experience added values in visiting the vendor 304.

In an alternative embodiment, with the popularity and versatility of portable computing devices (e.g., 126, 128, or 801), such as a smartphone, a smart watch, a smart wristband, the payment processing servers 106 may be coupled to a client app or software 130 to be installed on the portable computing devices. The client app or software 130 may be instantiated on the portable computing device and may store information of the payment device, such as a credit card, a debit card, a gift card, or the like. In addition, the client app 130 may also include billing address information as part of the storing of the information of the payment device. The client app 130 may have access to the geographical information devices of the portable computing devices, such as the GPS chip, cellular transmission transceiver, Bluetooth chip, etc. By accessing the geographical information, the client app 130 may interpret that the user may be making a geographical area request when the geographical information received by the client app 130 is different from that of the billing address. In one embodiment, the client app 130 may pre-fetch the results for the user 102 or traveler 104. In another embodiment, the client app 130 may wait for the user to confirm the request before providing the result.

In a further alternative embodiment, the user 102 or traveler 104 may call the banks informing them that he or she would be traveling such that, if the banks see any charge attempts or charge authorizations that are outside of their domicile or frequently traveled locations, the banks should not deny them or flag them as fraudulent charges. If the user 102 or traveler 104 makes such call and he or she has the client app 130 installed on the portable computing device, the banks may cause a note be transmitted through the payment processing servers 106 to the client app 130 such that the client app 130 may perform the pre-fetching or provide notification whether the client app 130 should perform pre-fetching.

In another alternative embodiment, the payment processing servers 106 may interpret an attempt of transactions by the user 102 or traveler 104 outside their billing address as a geographical area request, seeking recommendation based on the geocentric designator or group.

Therefore, embodiments of the invention may enable payment processing servers 106 give more accurate geocentric information about any given vendors based on past and ongoing transactions records. It is also contemplated that the user 102 or traveler 104 may provide feedbacks based on the accuracy of the information in the provided result to further assist the payment processing servers 106 to fine-tune the accuracy of future results. In a further embodiment, the payment processing servers 106 and or the recommendation server 120 may receive additional sources, such as news reports of major events at a given location, social networking sites, etc.

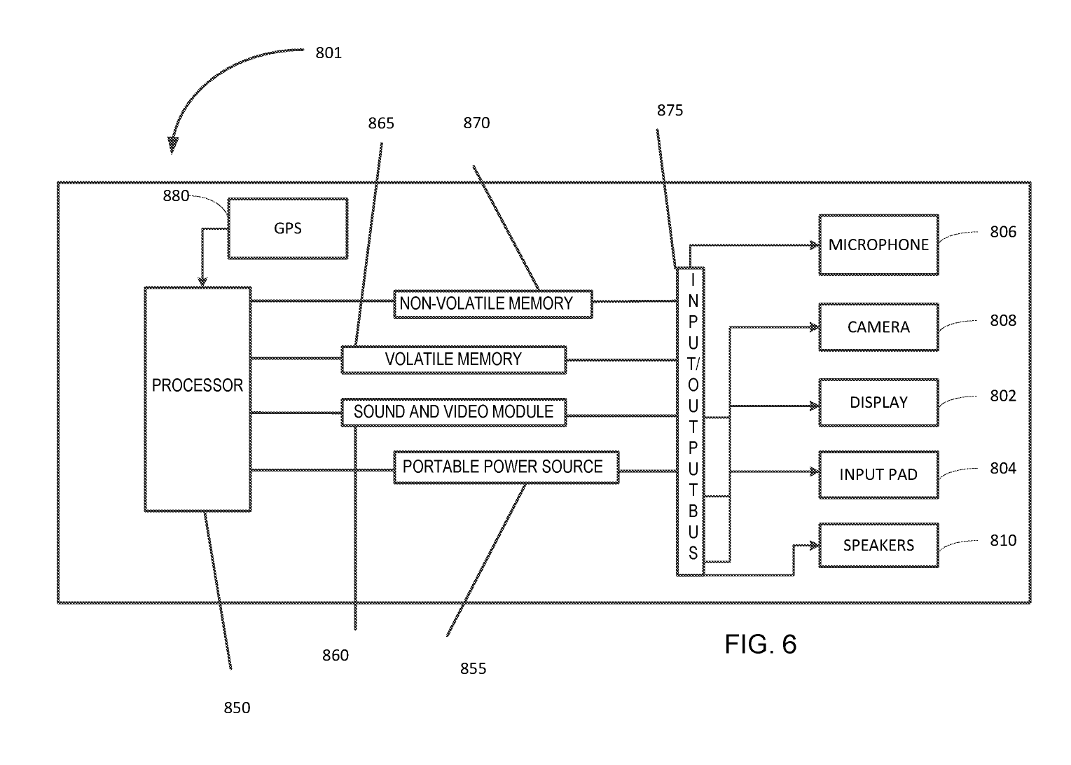

FIG. 6 may be a high level illustration of a portable computing device 801 communicating with a remote computing device 841 but the application may be stored and accessed in a variety of ways. In addition, the application may be obtained in a variety of ways such as from an app store, from a web site, from a store Wi-Fi system, etc. There may be various versions of the application to take advantage of the benefits of different computing devices, different languages and different API platforms.

In one embodiment, a portable computing device 801 may be a mobile device 112 that operates using a portable power source 855 such as a battery. The portable computing device 801 may also have a display 802 which may or may not be a touch sensitive display. More specifically, the display 802 may have a capacitance sensor, for example, that may be used to provide input data to the portable computing device 801. In other embodiments, an input pad 804 such as arrows, scroll wheels, keyboards, etc., may be used to provide inputs to the portable computing device 801. In addition, the portable computing device 801 may have a microphone 806 which may accept and store verbal data, a camera 808 to accept images and a speaker 810 to communicate sounds.

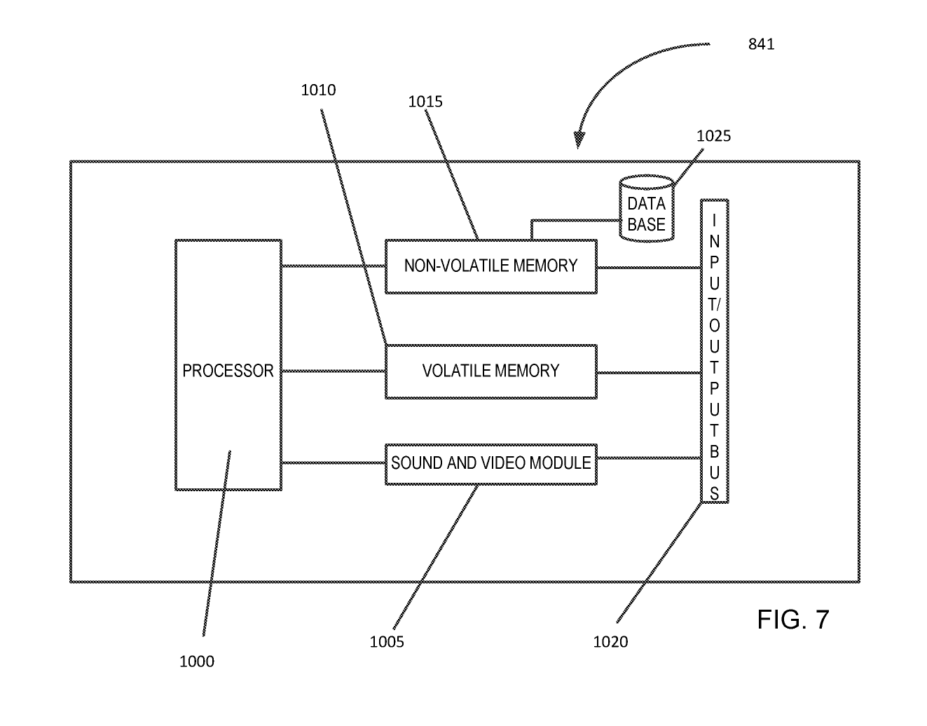

The portable computing device 801 may be able to communicate with a computing device 841 or a plurality of computing devices 841 that make up a cloud of computing devices 811. The portable computing device 801 may be able to communicate in a variety of ways. In some embodiments, the communication may be wired such as through an Ethernet cable, a USB cable or RJ6 cable. In other embodiments, the communication may be wireless such as through Wi-Fi (802.11 standard), Bluetooth, cellular communication or near field communication devices. The communication may be direct to the computing device 841 or may be through a communication network 102 such as cellular service, through the Internet, through a private network, through Bluetooth, etc. FIG. 6 may be a simplified illustration of the physical elements that make up a portable computing device 801 and FIG. 7 may be a simplified illustration of the physical elements that make up a server type computing device 841.

FIG. 6 may be a sample portable computing device 801 that is physically configured according to be part of the system. The portable computing device 801 may have a processor 850 that is physically configured according to computer executable instructions. It may have a portable power supply 855 such as a battery which may be rechargeable. It may also have a sound and video module 860 which assists in displaying video and sound and may turn off when not in use to conserve power and battery life. The portable computing device 801 may also have volatile memory 865 and non-volatile memory 870. It may have GPS capabilities 880 that may be a separate circuit or may be part of the processor 850. There also may be an input/output bus 875 that shuttles data to and from the various user input devices such as the microphone 806, the camera 808 and other inputs, such as the input pad 804, the display 802, and the speakers 810, etc. It also may control of communicating with the networks, either through wireless or wired devices. Of course, this is just one embodiment of the portable computing device 801 and the number and types of portable computing devices 801 is limited only by the imagination.

As a result of the system, better information may be provided to a user at a point of sale. The information may be user specific and may be required to be over a threshold of relevance. As a result, users may make better informed decisions. The system is more than just speeding a process but uses a computing system to achieve a better outcome.

The physical elements that make up the remote computing device 841 may be further illustrated in FIG. 7. At a high level, the computing device 841 may include a digital storage such as a magnetic disk, an optical disk, flash storage, non-volatile storage, etc. Structured data may be stored in the digital storage such as in a database. The server 841 may have a processor 1000 that is physically configured according to computer executable instructions. It may also have a sound and video module 1005 which assists in displaying video and sound and may turn off when not in use to conserve power and battery life. The server 841 may also have volatile memory 1010 and non-volatile memory 1015.

The database 1025 may be stored in the memory 1010 or 1015 or may be separate. The database 1025 may also be part of a cloud of computing device 841 and may be stored in a distributed manner across a plurality of computing devices 841. There also may be an input/output bus 1020 that shuttles data to and from the various user input devices such as the microphone 806, the camera 808, the inputs such as the input pad 804, the display 802, and the speakers 810, etc. The input/output bus 1020 also may control of communicating with the networks, either through wireless or wired devices. In some embodiments, the application may be on the local computing device 801 and in other embodiments, the application may be remote 841. Of course, this is just one embodiment of the server 841 and the number and types of portable computing devices 841 is limited only by the imagination.

The claimed system and method may address several technical problems and challenges, some of which are described. Currently, entering potential sensitive data across networks makes users nervous to the point that a sale may be lost or money or time saving tips or coupons may not be received. By using a proprietary network such as a payment network, to transfer potentially sensitive data, security may be higher and users may be more open to joining additional beneficial programs. Similarly, moving data from one payment system to another loyalty system has felt risky to some users, but by using a proprietary, trusted network, the data may be communicated in a more trustworthy fashion. In addition, formatting data and communicating data in a manner which may be understood by a variety of additional programs is a technical challenge or problem which the system and method has addressed.

The user devices, computers and servers described herein may be general purpose computers that may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. The user devices, computers and servers described herein may be running on any one of many operating systems including, but not limited to WINDOWS, UNIX, LINUX, MAC OS, or Windows (XP, VISTA, etc.). It is contemplated, however, that any suitable operating system may be used for the present invention. The servers may be a cluster of web servers, which may each be LINUX based and supported by a load balancer that decides which of the cluster of web servers should process a request based upon the current request-load of the available server(s).

The user devices, computers and servers described herein may communicate via networks, including the Internet, WAN, LAN, Wi-Fi, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above may be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, the systems and methods described herein may be configured for improving user transaction systems. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

What is claimed is:

1. An electronic system to interactively manage multiple parties to create a geocentric designator comprising:
a payment server comprising a memory, an input-output circuit and a processor physically configured according to computer executable instructions for:
receiving a plurality of transactions from a plurality of users, wherein the plurality of transactions comprises a billing address of each of the plurality of the transactions and each purchase address of each of the parties;
analyzing the plurality of transactions using an analysis module to, for the each purchase address of each of the parties, differentiate from the plurality of users one of more geocentric groups as a function of the billing address of each of the plurality of transactions and the each purchase address of each of the parties;
accumulating potential one or more geocentric groups for the each purchase address of the plurality of parties using an accumulation module;
for each of the parties, identifying, in response to accumulating, a group from the one or more geocentric groups to be associated with a party that satisfies a threshold geocentric value;
assigning by a designator module a geocentric designator to the party in response to the identified group for satisfying the threshold geocentric value;
a recommendation server comprising a memory, an input-output circuit and a processor physically configured according to computer executable instructions for:
at a query module, receiving from a user a geographic area request of each purchase address of the plurality of parties; and
based on the geocentric designator, providing, by the query module, to the user a result based on the plurality of parties in response to the received geographic area request.

2. The electronic system of claim 1, wherein the recommendation server is further configured to communicate to a portable computing device of the users the result.

3. The electronic system of claim 1, wherein the recommendation server is further configured to receive feedbacks on the geocentric designator from the users on the plurality of the parties in response to receiving the result, wherein the recommendation server is configured to update the geocentric designator in response to the received feedbacks.

4. The electronic system of claim 1, wherein the recommendation server is configured to receive information from other sources to update the geocentric designator for each of the plurality of parties.

5. The electronic system of claim 1, wherein the payment server, via the designator module, is configured to modify an identification associated with each of the plurality of the parties in response to assigning.

6. The electronic system of claim 1, wherein the recommendation server is further configured to provide offers to the users as a function of the result.

7. A computerized method for interactively managing multiple parties to create a geocentric designator comprising:
receiving, by a payment server, a plurality of transactions from a plurality of users, wherein the plurality of transactions comprises a billing address of each of the plurality of the transactions and each purchase address of each of the parties;
analyzing, by the payment server, the plurality of transactions to, for the each purchase address of each of the parties, differentiate from the plurality of users one of more geocentric groups as a function of the billing address of each of the plurality of transactions and the each purchase address of each of the parties;
accumulating, by the payment server, potential one or more geocentric groups for the each purchase address of the plurality of parties;
for each of the parties, identifying, by the payment server, in response to accumulating, a group from the one or more geocentric groups to be associated with a party that satisfies a threshold geocentric value;
assigning, by the payment server, a geocentric designator to the party in response to the identified group for satisfying the threshold geocentric value;
receiving, by a recommendation server being communicatively coupled to the payment server, from a user a geographic area request of each purchase address of the plurality of parties; and
based on the geocentric designator, providing, by the recommendation server, to the user a result based on the plurality of parties in response to the received geographic area request.

8. The computerized method of claim 7, further comprising providing a client software program product for installation on a portable computing device of the users for enabling the portable computing device to interface with the payment server and the recommendation server.

9. The computerized method of claim 8, further comprising communicating to the portable computing device of the users the result.

10. The computerized method of claim 7, further comprising receiving feedbacks on the geocentric designator from the users on the plurality of the parties in response to receiving the result.

11. The computerized method of claim 10, further comprising updating the geocentric designator in response to the received feedbacks.

12. The computerized method of claim 7, further comprising receiving additional information from other sources to update the geocentric designator for each of the plurality of parties.

13. The computerized method of claim 7, wherein assigning comprises modifying an identification associated with each of the plurality of the parties.

14. The computerized method of claim 7, further comprising providing offers to the users as a function of the result.

15. A computerized method for interactively managing multiple parties to create a geocentric designator comprising:
storing payment information related to a user on a memory of a portable computing device, said payment information including at least the following information: information about the a payment device, and information about a first address of the payment device, information about receiving;
establishing a connection with a payment server via a payment processing network;
transmitting a geographical area request to the payment server, the geographical area request including information about a second address, said second address being different from the first address;
identifying a geocentric designator in a data packet received from the payment server as a result of processing the geographical area request by analyzing the first address to the second address; and
providing a result to the user on the portable computing device based on the identified geocentric designator.

16. The computerized method of claim 15, wherein transmitting comprises transmitting the geographical area request in response to receiving geographical data information of the portable computing device.

17. The computerized method of claim 16, further comprising determining the second address as a result of receiving the geographical data information of the portable computing device

18. The computerized method of claim 15, wherein identifying the geocentric designator comprises identifying the geocentric designator in an identification data field or in a designator data field in the data packet from the payment server.

19. The computerized method of claim 15, further comprising providing offers on the portable computing device to the user in response to the provided result.

20. The computerized method of claim 15, further comprising receiving feedbacks from the user on the portable computing device in response to the provided result.
